(19) United States
(12) Patent Application Publication
(10) Pub. No.: US 2005/0278292 A1
(43) Pub. Date: Dec. 15, 2005

(54) Spelling variation dictionary generation system

(75) Inventors: Hiroko Ohi, Kokubunji (JP); Osamu Imaichi, Wako (JP); Yoshiki Niwa, Hatoyama (JP)

Correspondence Address: Stanley P. Fisher;Reed Smith LLP, Suite 1400, 3110 Fairview Park Drive, Falls Church, VA, 22042-4503, US

(73) Assignee: Hitachi, Ltd.

(21) Appl. No.: 10/988,973

(22) Filed: Nov. 16, 2004

(30) Foreign Application Priority Data
Jun. 11, 2004 (JP) 2004-174516

(51) Int. Cl. G06F 7/00

(52) U.S. Cl. 707/1

(57) ABSTRACT

A system for effectively collecting, without omissions, spelling variations centering on particular technical terms occurring in documents. In advance, the system sorts technical terms considered to be potential spelling variations from among a large-scale collection of terms. By measuring the edit distance adjusted for the cost of the terms that are potential spelling variations, the system can collect terms considered spelling variations from among the potential spelling variation terms with a high degree of accuracy.

### CLAIM OF PRIORITY

The present application claims the benefit under 35 U.S.C. § 119 of the earlier filing date of Japanese Patent Application JP 2004-174516 which was filed on Jun. 11, 2004, the content of which is hereby incorporated by reference into the present application.

### BACKGROUND OF THE INVENTION

1. Field of the Invention

The present invention relates to systems and methods for extracting, without omissions, spelling variations of terms used in documents and relates in particular to a method for extracting technical terms, e.g., from medical biology literature on a large scale.

2. Description of the Background

When using terms (herein, single or compound words) as written words, spelling variations of these terms may sometimes occur. Examples of typical variations include “leucocyte” and “leukocyte” or “sulphate” and “sulfate.” When these kinds of spelling variations occur in terms expressing the same item, omissions occur in the results provided from searches or information retrieval systems that do not take these spelling variations into account.

For example, in systems that extract and provide information from documents in response to user requests, specialist dictionaries (e.g., biology dictionaries) in the field of interest are initially prepared, the system retrieves sections from a document that matches the specialist dictionary, and information matching the specified user request is provided over a graphical user interface (“GUI”). In this way, the user efficiently collects valuable information matching the user's field of interest.

However, when retrieving information in these types of systems using specialist dictionaries possessing only one spelling, a problem arises in that sections in the document containing spelling variations will be omitted from the information extraction results. When the document, for example, contains the spelling variation “leucocyte” but the term dictionary only lists the term “leukocyte,” then information written for “leucocyte” will be omitted from the information retrieval results even though the terms “leucocyte” and “leukocyte” indicate the same item.

Coping with this type of problem requires forming dictionaries capable of handling spelling variations and contriving an information search and information retrieval system made up of dictionaries that can deal with these spelling variations. In dictionaries that handle spelling variations, the spelling variation terms are stored beforehand as synonyms of the original term, and during information retrieval in systems containing spelling variation dictionaries, the spelling variation terms are also retrieved. Therefore in the previous example, “leucocyte” would be stored as a synonym of “leukocyte”, and when the term “leucocyte” is input as a search term, the terms “leucocyte” and “leukocyte” are both retrieved.

In spelling variation dictionaries, the entry word and the spelling variation terms are generally linked manually or by computer, and the spelling variation term obtained in this way is stored in the dictionary. In the “different spelling term dictionary creation assist device” disclosed in JP-A No. 73197/1995 for matching spelling variation terms with entry words using a computer, the spelling variations of terms are collected by judging the similarity between terms within the index words.

In the “similar text retrieval device” disclosed in JP-A No. 288366/2003, the similarity is calculated by a method that finds matches among the N-gram elements of the respective terms, and the terms are then matched in a form that absorbs the spelling variations. Here, the N-gram is a data format (index of terms) consisting of subsequences connecting the term. The number of characters in the subsequence is specified in N (a natural number). For example, when using N=3 in the term “NICAA’, the term is divided up into elements of three consecutive characters called “NIC”, “ICA”, “CAA” to make an index for the term. To calculate the degree of similarity in the N grams, subsequences of N characters jointly contained in both character strings are found. Thereafter, weighted values are assigned to these common subsequences. These weights are then added for all matching sections, and the total sum obtained from this addition constitutes the overall N-gram degree of similarity.

In the manual method, creating a spelling variation dictionary by finding and storing all the spelling variations for the entry word is difficult. The method in JP-A No. 73197/1995, on the other hand, extracts terms in order from among the index words collected from terms in response to the query, compares them to the remaining index words and calculates the degree of similarity. If the degree of similarity is an established preset figure or higher, the system retrieves the term as a spelling variation (term with a different spelling). The character sequences (or strings) are linked by a method such as the LCS (Longest Common Subsequence) method, or the Heckel method. Here, after linking a pair of character sequences, the matching character sequence length, mismatch character sequence length, and/or number of matching categories are used to rate the degree of similarity according to the longer the character sequence, or the shorter the mismatch character sequence and so forth. The degree of similarity of a pair of character strings is then converted to a number.

However, in this type of method for calculating the degree of similarity, when the number of index words increases, the number of character sequence combinations also increases, and when the character string length for a term becomes long, the link between character sequences becomes complicated. In either of these cases, the calculating load becomes excessive and this method becomes impractical in terms of calculation time. Furthermore, when the difference between character sequence lengths becomes too large, spelling differences cannot effectively be determined. Methods are available to eliminate similar character sequences whose lengths differ too greatly but after finding similar character sequences the process of narrowing them down is inefficient.

In the method disclosed in JP-A No. 288366/2003, the match between respective N-gram elements in a text is calculated in order to calculate the degree of similarity in the text, and those with a high degree of similarity are determined to be “similar text.” For example, when there are the two terms “winodws” and “windows2000” for the entry word “windows”, the character sequence “winodws” appears to be the spelling variation. In this method, the three gram elements “win”, “ind”, “ndo”, “dow”, and “ows” are generated for “windows”; the elements “win”, “ino”, “nod”, “odw”, “dws” are generated for “winodws”; and the three gram elements “win”, “ind”, ndo”, “odw”, “dow”, “ows”, “ws2”, “s20”, “200”, “000” are generated for “windows2000”. The term “windows” is given a (degree of) similarity 1, and “windows2000” is given a similarity of 5. Therefore, the character sequence “windows2000” has a higher degree of similarity than “winodws,” even though “winodws” is the obvious spelling variation (mistake).

### SUMMARY OF THE INVENTION

The present invention, therefore, provides a means for effectively collecting, without omissions, spelling variations occurring in documents centering on a term (e.g., an entry word in a dictionary). The present invention preferably sorts terms considered as potential spelling variations in advance from among a large-scale collection of terms, measures the edit distance adjusted for the cost of terms that are potential spelling variations, and then collects terms considered spelling variations from among the potential spelling variation terms.

The system of the present invention, utilized for retrieving spelling variations of terms given as queries, is preferably made up of: a term collection section for collecting groups of terms from a text document; a similar term query section for searching the group of similar terms from among the group of terms collected by the term collection section; and a spelling variation query section for retrieving spelling variations of query terms from among the group of terms retrieved by the similar term query section. The similar term query section judges the degree of similarity of two compared terms based on the extent of common usage in adjoining subsequences of a specified length offset by one character. Then the spelling variation query section retrieves the term whose total cost for edit distance with the query term is smaller than the supplied threshold as the true spelling variation for the query term.

The present invention is preferably capable of collecting spelling variations with a high degree of accuracy (without omitting true spelling variations) and with little effort on the user's part. The system is capable of collecting information without omissions even in cases in which there are spelling variations within the retrieval results when retrieving information containing these spelling variations.

### BRIEF DESCRIPTION OF THE DRAWINGS

For the present invention to be clearly understood and readily practiced, the present invention will be described in conjunction with the following figures, wherein like reference characters designate the same or similar elements, which figures are incorporated into and constitute a part of the specification, wherein:

FIG. 1 is a block diagram showing the system structure of the spelling variation dictionary generation system;

FIG. 2 shows a typical user interface for making a spelling variation dictionary;

FIG. 3 is a diagram showing the overall structure of the processing means for the server calculation device;

FIG. 4 is a flow chart showing the process flow for making a spelling variation dictionary;

FIG. 5 is a drawing showing in detail the process for collecting terms;

FIG. 6 is a drawing showing in detail the process for indexing;

FIG. 7 shows exemplary data generated in the index generating means (module of indexing) for subsequences;

FIG. 8 is a detailed diagram of the process performed by the similar character sequence retrieval means (module);

FIG. 9 is a detailed diagram of the process performed by the spelling variation query means (module);

FIG. 10 is a diagram showing the cost for the character string edit distance operation;

FIG. 11 is a table showing calculations for the character string edit distance;

FIG. 12 shows an example of collecting spelling variations in three sequential steps (FIG. 12A, FIG. 12B and FIG. 12C);

FIG. 13 is a drawing showing an exemplary user interface;

FIG. 14 is a diagram for describing the spelling variation collection process;

FIG. 15 is a diagram showing the process performed by the term collection means (module);

FIG. 16 is a diagram showing the process performed by the indexing means (module);

FIG. 17 is a diagram showing the process performed by the similar character sequence query means (module); and

FIG. 18 is a diagram showing the process performed by the spelling variation query section.

### DETAILED DESCRIPTION OF THE INVENTION

The present invention is especially effective in producing spelling improved variation dictionaries.

However, the applications of the present invention are not limited to making spelling variation dictionaries and can be incorporated into other technical disciplines by those skilled in the art. The sections comprising the core of the present invention are described in detail in the following and applications for carrying out the invention are described by utilizing specific embodiments thereafter.

In the present invention, candidate spelling variations for entry words are initially collected and the spelling variations further screened (sorted) from among the collected candidates. More specifically, the following process is performed. The example here describes the collection of spelling variations for the term “iccar”.

Initially, the terms requiring a search for spelling variations are prepared. In this case, “iccar” is utilized as described above. Next, terms are taken from document data in a field where the entry words often appear utilizing a pre-existing method. Here to give one example, the terms extracted from the text data by the pre-existing method may be nouns appearing in the text. In the example description, “iccar” often appears in biological fields so terms are extracted from documents in the field of biology and terms such as “ICCAR”, “ICAA”, “aar”, “Schaar”, “CaARN1”, “alpha1aAR” are collected.

Next, terms similar to the entry words (candidate spelling variations for terms) are collected from the collection of extracted terms. The candidates at this time are collected only to the threshold number set by the user in the parameter “k” and are sorted in order of similarity. The method for calculating this similarity in order to collect candidate spelling variations for the term utilizes both an N-grams index and also indexes the terms according to character sequence length for each term extracted by the pre-existing method and entry word.

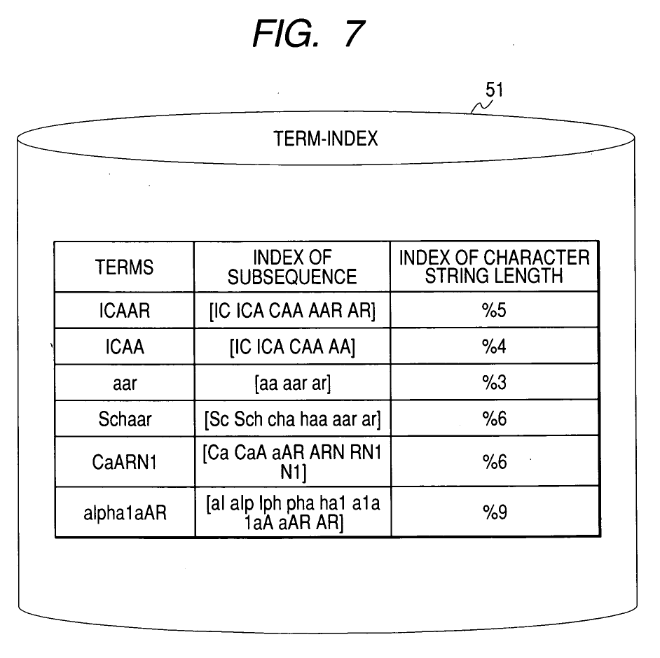

Unlike the method for calculating similarity in JP-A No. 288366/2003, rather than simply using N-grams, this method utilizes N-grams indexed by character sequence length. An N-gram indexed by character sequence length is shown in FIG. 7. The term “ICAAR” for example, contains the following subsequences for a the 3-gram index: [IC, ICA, CAA, AAR, AR] (where “[” and “]” are symbols indicating the start and end of a character sequence, respectively). The character sequence length index for “ICCAR” is “%5”.

The method for calculating similarity establishes a weight for common index items. These weights are then summed for all matching sections. The total sum obtained represents the overall similarity of the character sequence. Performing the calculation using a weight of 1 gives “ICCAR” and “ICCA8” a similarity of 3 and the character sequence length a similarity of 1. In this example, the weight was 1 when the N-grams matched; however the weight can be set to a higher number when the N-gram index contains a special character. In other words, the weight can be adjusted according to which type of character sequence in the system has greater similarity.

Terms possessing a number of characters that are ±m of the entry word are preferably collected as candidate spelling variations. The parameter “m” can be set by the user. A method for restricting the length is given as follows. In this example, it is assumed that the sequence length of the term is four (%4) and the user has selected a tolerance of ±2 characters.

An index (e.g., %2, %3, %4, %5, %6 when making an index with a tolerance of ±2 for a four character sequence) is generated according to the tolerance of the number of character sequences for the entry word, and an index for the character sequence length (e.g., an index %4 if the number of characters is four) is generated for the extracted term by the pre-existing method. A weight is applied when holding a common index element, the same as when calculating similarity by utilizing N-grams, and the similarity of that character sequence length is calculated by adding the character sequence weights. If the term is within the tolerance range of the character sequence length, then the similarity of the character sequence length becomes “1”.

The restriction on length can therefore be met by collecting character sequences with a high similarity, and also possessing a character string length of 1, and terms similar to the entry word can be collected. Generating a 3-gram index, for example for “iccar”, and further having a tolerance 2 for the number of character sequences creates: [ic, icc, cca, car, ar] as subsequences with acceptable lengths: %3, %4, %5, %6, %7. Measuring the similarity of the retrieved terms versus the term “car” yields an index of: [ca, car, ar], with length “%3”. Therefore, the similarity is 2 and the character sequence length has a similarity of 1.

The reason for adding a length restriction when collecting similar character sequence candidates is that the number of characters might greatly increase or decrease due to spelling variations. This restriction therefore eliminates the collecting of similar terms that are not spelling variations (e.g., “Windows2000”).

The similarity is calculated in this way, and the candidate spelling variation terms are collected by character sequence lengths whose similarity is one (1) and are further collected in order of high similarity by setting a number in the parameter k. At this point, the candidate spelling variation terms that were collected do not contain only those terms that are spelling variations of the term but are also mixed with words that merely resemble the term. Therefore the edit distance between the entry word and spelling variation candidate term is subsequently measured in order to further narrow down the number of terms that are classified as true spelling variations.

The edit distance is preferably measured in order to obtain the distance between one character sequence and another character sequence, and it indicates the number of character operations (insertion, deletion, and substitution) that are necessary to transform one term into another. However, differences in the importance of various operations will appear due to the type of operation and character such as a completely different object being indicated due to a character sequence substitution, or an object failing to change even if inserted with a sign. Therefore, when collecting spelling variations, utilizing an edit distance with a “cost” altered by these types of characters and operations allows setting a low edit distance when handling spelling variations, and narrows down the number of spelling variations.

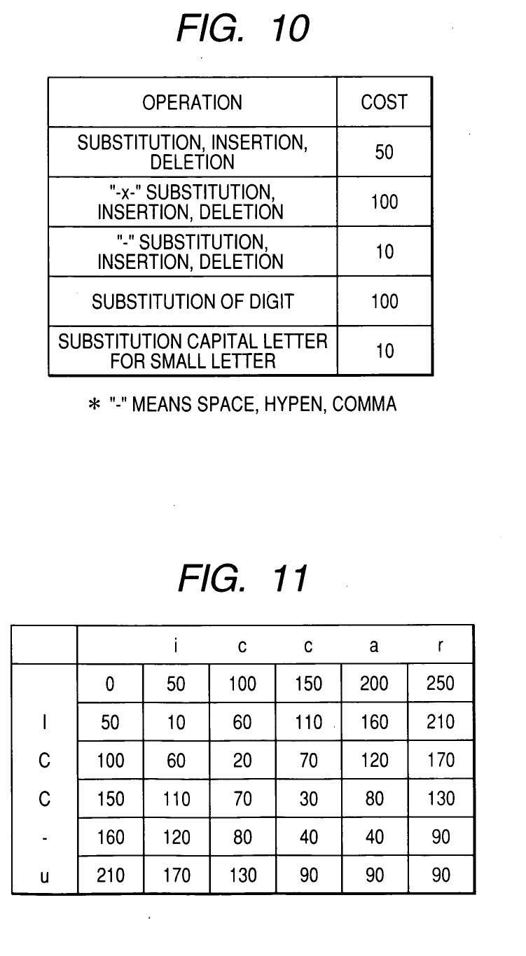

Therefore in the present invention, the weight of the operations is set low for insertion, deletion, and substitution of characters which are considered spelling variations, and is set higher for operations that are not considered to be mere spelling variations. As shown in FIG. 10, when making cost settings, substituting numbers between character strings is not considered likely to be a spelling variation, so a figure of 100 is applied as a high cost. On the other hand, the substitution of capital and lowercase letters is considered likely to be a spelling variation, so a lower number, e.g., 10, is applied as a low cost for calculating the edit distance. Therefore terms occurring from spelling variations among the candidate spelling variation terms are characterized by an edit distance with a low overall cost.

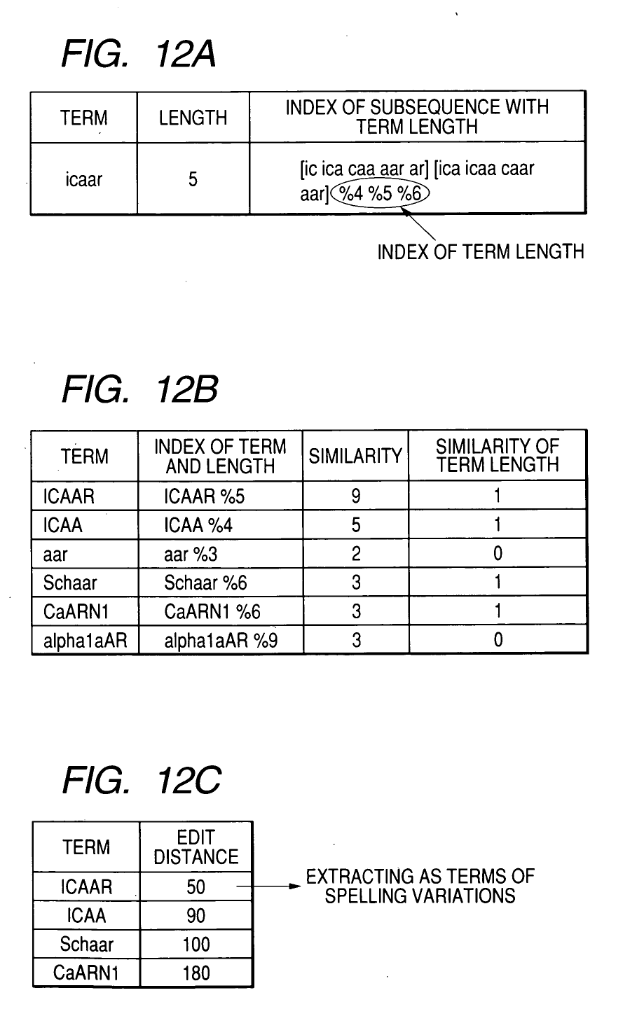

Calculating the edit distance of “iccar” and “ICC-u” using the cost table of FIG. 10, yields an edit distance of 90. The operation for calculating the edit distance is described in FIG. 11. The cost is inserted in the matrix for C_{0 . . . |x|, 0 . . . |y|}. Here, |x| expresses the length of the character sequence, xᵢ indicates the i^{th} character. Cᵢⱼ is the minimum cost that was calculated, and is input between the X_{1 . . . i} and Y_{1 . . . j}. Here, c indicates the cost relating to the operation shown in FIG. 10.
C_{i,0}=i*50
C_{0,j}=j*50
C_{i,j}=if (xᵢ=yⱼ) then C_{i-1,j-1} else c+min(C_{i-1,j}, C_{i, j-1}, C_{i-1,j-1})

The cost obtained at the lower right on the matrix is the total cost for the edit distance. When the total cost has become lower than the preset threshold value, then that term is set as a spelling variation of the entry word. The user preferably sets the threshold value.

### First Exemplary Embodiment

This embodiment shows the structure for constructing a spelling variation dictionary according to the present invention. The user sets the master dictionary comprising the object for collecting the spelling variations as well as text and parameters for collecting the spelling variations. The user in this way makes a dictionary corresponding to the spelling variations that are output. Spelling variations are collected from the text for each entry word in the dictionary. These spelling variations are then stored in the dictionary and the overall spelling variation dictionary is formed in this way.

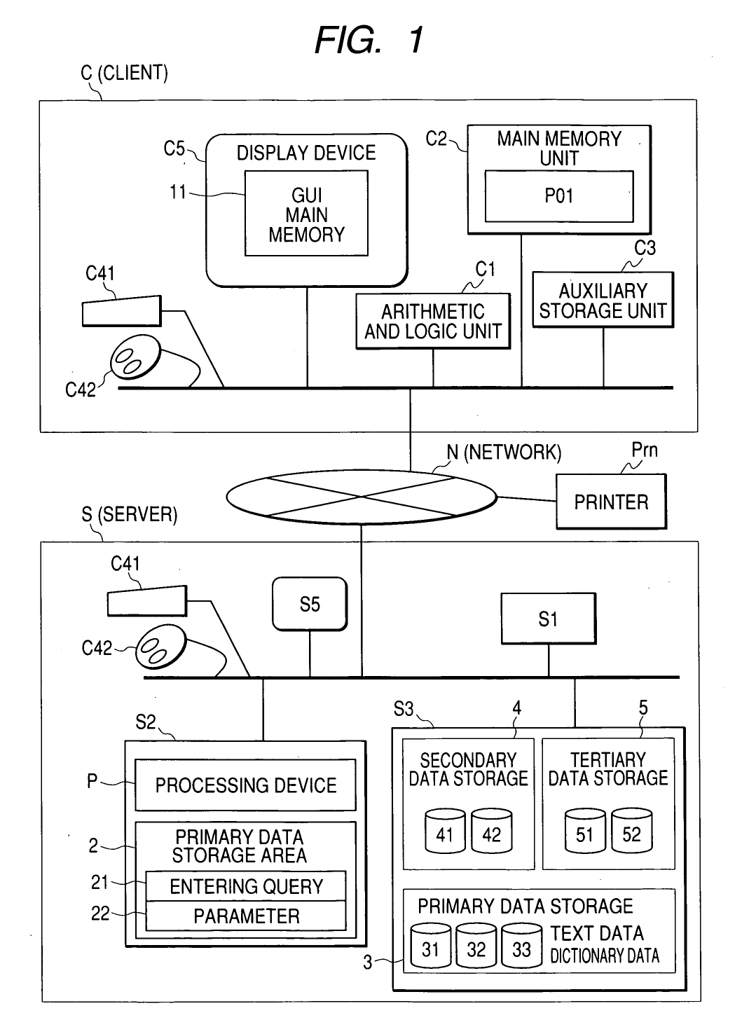

FIG. 1 is a block diagram showing the overall system structure of the spelling variation dictionary generating system. This system is made up of a client computer device C, a server computer device S, and a communication network N. A structure is also possible that utilizes the same computer device as the client computer device C and server computer device S, and does not necessarily use a computer network. A printer device Prn may also be utilized, if desired.

The client computer device C is made up of an arithmetic and logic unit (“ALU”) C1 and main memory unit C2, an auxiliary storage unit C3, a keyboard C41 and a mouse C42 as input means, and a display means C5. A client control means P01 operating in the main memory unit C2, displays a GUI on the display device C5 and performs unified control of the overall process in the client computer device C.

The server computer device S is preferably made up of an arithmetic and logic unit S1, a main memory unit S2, an auxiliary memory unit S3, a keyboard S41 and a mouse S42 as input means, and a display means S5. The following processing means group operates in the main memory means S2 of the server computer device S. These processes temporarily utilize the search request 21 and the parameter 22 as the primary data storage area 2 and maintain them in an active or fixed state in the main memory unit S2.

The text data 31 forming the primary data 3 and the dictionary 32, and each process generated there are checked (or referred to), and the secondary data 4 is stored in the auxiliary memory storage unit S3 of the server computer device S. The data checked for the generated processes is stored as the tertiary data 5.

The terms 41 extracted from the text data 31 are contained in the secondary data 4. The tertiary data 5 contains data such as N-gram data (terms and N-gram data for terms) generated from the term 41.

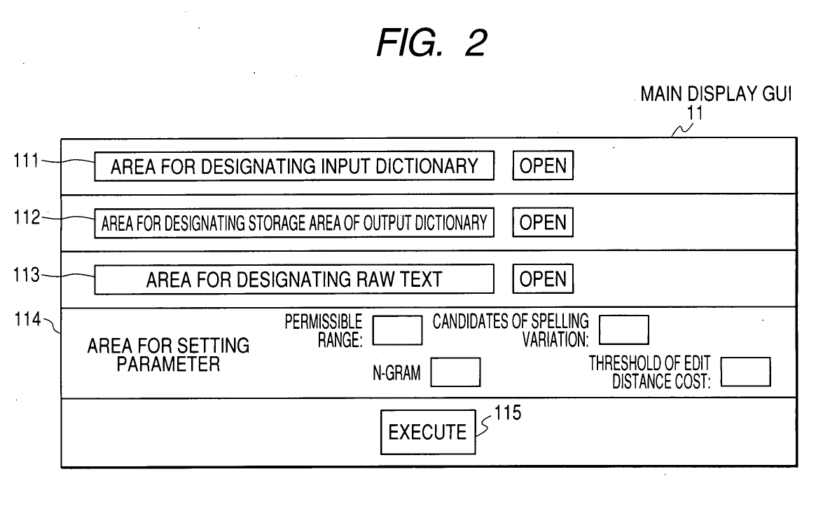

FIG. 2 is a diagram showing a typical user interface for setting parameters and requests such as making a dictionary. The GUI for the main display 11 of the client computer device in FIG. 1 is made up of an area for designating input dictionary 111 for (designating) entry to a master dictionary input that stores the entry word forming the basis for finding spelling variations. There is also an area for designating the storage area of the output dictionary 112 on a spelling variation dictionary, an area for designating raw text 113 (section for designating documents for extracting spelling variations), and an area for setting the parameters 114 such as the number of spelling variation candidates. An execute button 115 begins the search process.

In the area for setting the parameters 114, the degree of tolerance of character sequence lengths showing the extent of difference that is acceptable in the character sequence length of the spelling variation candidate versus the character sequence length of the entry word is specified. The number of candidate spelling variations, whether to split up the text elements into how many connecting characters when generating N-grams, and threshold values for the total cost of the edit distance are also specified in the parameter setting area 114.

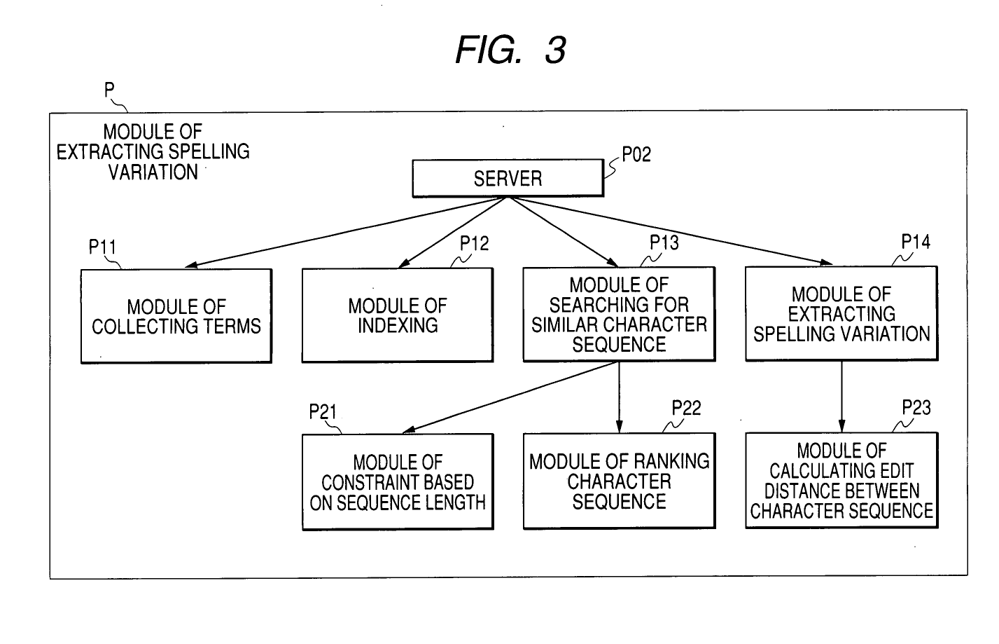

FIG. 3 is a diagram showing the entire structure of the processing means for the server calculation device. The server control module P02 provides unified control of all processing in the server computer devices. The server control module P02 directly calls up the module of collecting terms P11 for collecting terms from the text data 31, the module of indexing P12 for creating an index of subsequences, a module of searching for similar character sequences P13 for searching for similar character sequences by utilizing common subsequences, and a module of extracting spelling variations P14 for retrieving spelling variations by the edit distance between character strings. Modules operated by these elements include the module-of-constraint based on sequence length P21, a module of ranking character sequence P22 for appending a score to character sequences depending on the degree of commonality and then ranking the character sequence, and a module of calculating edit distance P23 between the character sequences. The data 51 is generated by the module of indexing P12 as shown in FIG. 7.

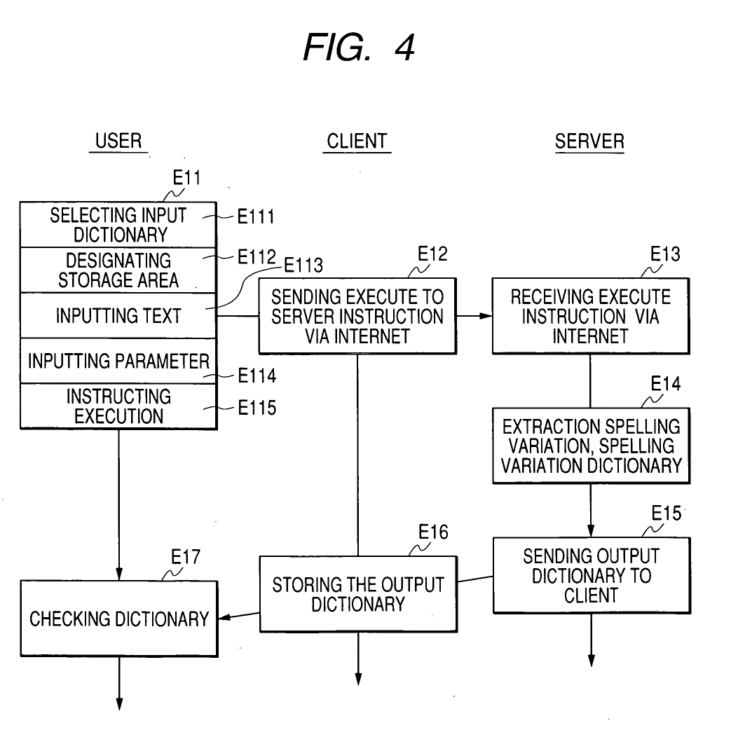

FIG. 4 is a diagram for describing the process for collecting spelling variations. The (vertical) line on the left shows the user operation flow. The (vertical) line in the center shows the process flow in the client computer device. The (vertical) line on the right shows the process flow in the server computer device.

The user initially selects the input dictionary in process E111 in the area for designating the input dictionary 111 on the main display (FIG. 2). The user then designates the dictionary output location in process E112 in the area for designating storage area of output dictionary 112. Next, in the area for designating raw text 113, the user selects the text for collecting spelling variations in process E113. The user then sets parameter values such as the number of queries in process E114 in the area for setting parameters 114. The user then presses the execute button 115 in the instructing execution process E115 to instruct collection of spelling variations. Collectively, these first user steps are combined as step E11.

The client control means (or module) P01 receives this instruction) and conveys the dictionary, text, and parameters over the communication network N (FIG. 1) such as a LAN or the Internet to the server control means (or module) P02 operating on the server computer device S (step E12). If the client computer device and the server computer device are the same device then the information (dictionary, text, parameters) is conveyed by communication means between processes.

The server control module P02 gives the dictionary, text, parameters to the module of extracting spelling variation means P based on the task request that P02 received (FIG. 3). The module of extracting spelling variation means P collects terms from the received text data 3 by using the module of collecting terms P11 and generates the secondary data 41. Next, the module of extracting spelling variation means P further processes the secondary data 41 by using the module of indexing P12 and generates the term-index data 51. The character sequence similarity of the query term is next searched based on the extent of common (commonality) subsequences while checking the term-index data 51 by using the module of searching for similar character sequences P13 on the words in the dictionary 32.

The similar character sequences are at this time searched within the tolerance range for character sequence length set by the user by placing restrictions on character sequence (string) length with the module of constraint based on sequence length P21. The module of ranking character sequence P22 ranks the character sequences by attaching a score for commonality of subsequences and establishes items with high similarity as candidate spelling variations. The candidate spelling variations for each entry word obtained in this way are further selected as spelling variations while checking the character string (or sequence) edit distance by using the module of extracting spelling variations P14.

The spelling variations obtained in this way are stored in the dictionary as spelling variations for each entry word, and a spelling variation dictionary is therefore obtained (generally, E13, E14 in FIG. 4).

Those (dictionaries) are then once again conveyed to the client control means P01 by communications over the network or between processes (E15). The client control means P01 stores the returned dictionaries in the location designated as the storage area of output dictionary 112 (El6), and the dictionary may be checked by the user (E17).

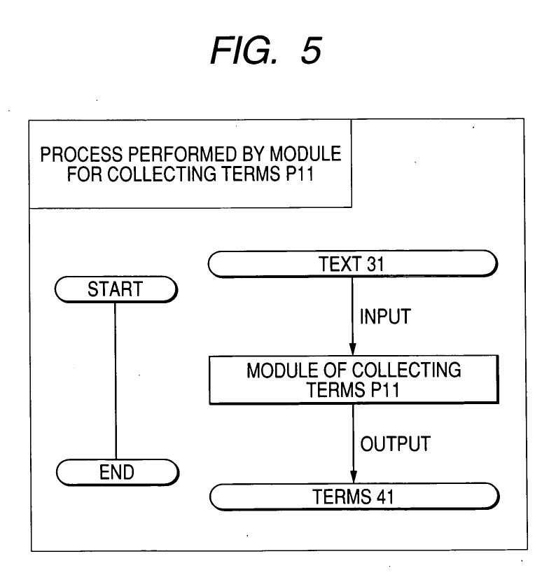

FIG. 5 is a diagram of the processing performed by the module for collecting terms P11. The module of collecting terms P11 collects terms from the text data 31 in this process and stores them as the term collection 41 of the secondary processed data. Here, the collection of terms from the text data 31 may, for example, be a collection of nouns appearing within the text.

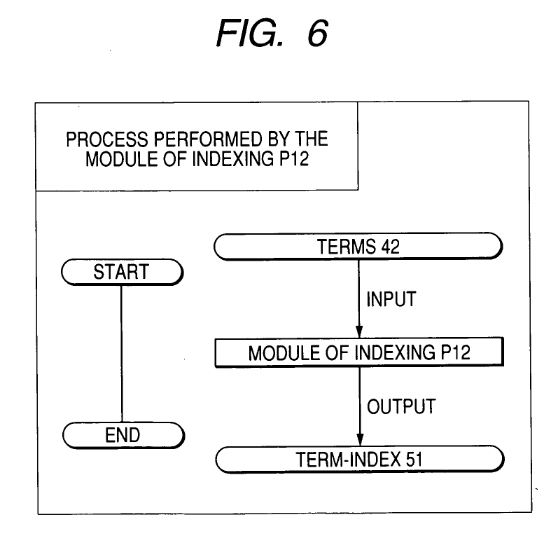

FIG. 6 is a diagram showing the process performed by the module of indexing P12 on the term collection 41 extracted from the text. The module of indexing P12 makes the term-index data 51 comprised of tertiary processed data from the term collection 41. FIG. 7 is an example of data from indexing using subsequences. Here the subsequence indexing is shown when the parameter of the N-gram is N=3. For example for the term, “ICAA”, an index of: [IC, ICA, CAA, AA] is made by dividing up the text into elements of three consecutive characters each. Again, “[” and “]” are symbols showing the beginning and the end of the character sequence (or subsequence). The character sequence length has an index added after the “%”. A feature of this data is possession of an index by the character string length.

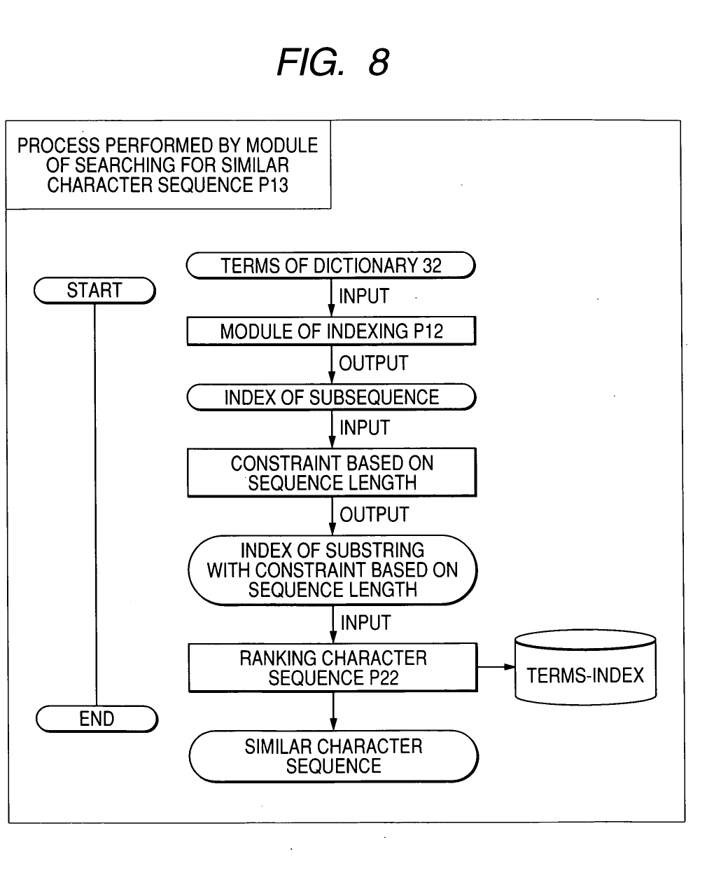

FIG. 8 is a diagram showing the process performed by the module for searching for similar character sequence. The entry words 32 are input, and the module of indexing P12 generates a subsequence index for that term. The character string, which increases and decreases per the spelling variations, may be as high as ±m so that a character sequence length of ±m is generated. The user specifies the tolerance “m.” When an index with a tolerance of ±1 and N=3 grams is made for the character sequence “iccar” with a character sequence length of 5, the result is a sequence of; [ic, icc, cca, car, ar], with acceptable lengths: “%4”, “%6”.

The term-index data 51 of the tertiary data is then checked, the similarity with term 41 is extracted from the text data 31, and the entry word is calculated. In this method for calculating similarity, a weight is set for common index items, and the weight for all matching sections is summed. The total sum obtained is the similarity of N-grams indexed by character sequence length. For example, the similarity of “ICCAR” and “ICCA8” is 3, and the similarity of the character sequence length is 1. The similar character sequences are output as upper k^{th} units in the order of character sequences with high similarity. The user specifies the value of “k.” These processes are performed for each entry word.

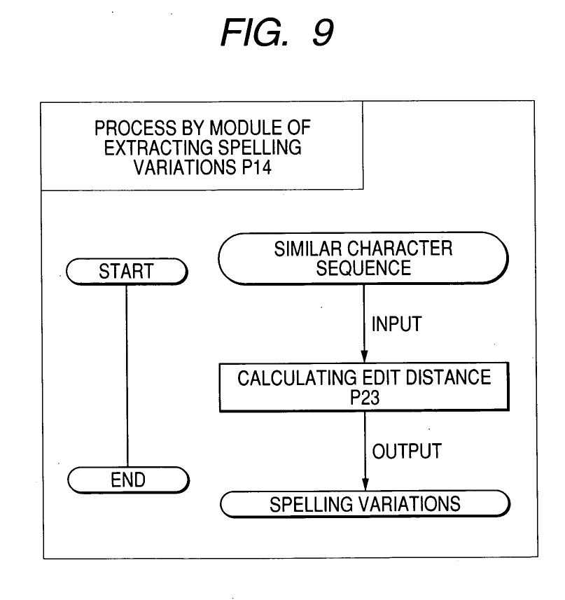

FIG. 9 is a diagram of the process by the module for extracting spelling variations P14 using the edit distances between character sequences. The similar character sequence is input and the character sequence edit distance is measured with the terms of the input dictionary. In calculating this edit distance, an edit distance with a weight set for a low cost is utilized for the insertion, substitution and deletion of the character sequence assumed to be a spelling variation. A term with an edit distance whose total cost is the same or lower than a threshold (set by the user) in a character sequence with a close edit distance, is determined to be a character sequence for a spelling variation of the input entry word. These processes are also performed on each entry word.

FIG. 10 is a table showing an example of the cost of calculating the edit distance. In this example, the insertion and deletion of a “hyphen” and substitution of capital and lowercase letters are assumed to be for spelling variations so the cost is set low. On the other hand, the substitution of numbers and the substitution, insertion or deletion of -x- (hyphen, character, hyphen) is assumed not to be a spelling variation, so the cost is set high.

FIG. 12A, FIG. 12B, and FIG. 12C, show examples of spelling variations that were collected. The example in FIG. 12A shows the making of an index of 3-gram and 4-gram subsequences for the entry word “iccar”, and the tolerance of the character sequence length is set at m=1 (because “icaar” has 5 letters, acceptable candidates have %4, %5, %6 characters). The number of spelling variation candidates is k=4, and with the edit distance threshold set at 60, spelling variations of “ICCAR” are collected. Here, “ICCAR”, “ICCA”, “aar”, “Schaar”, “CaARN1”, “alpha1aAR” were the terms collected from the text.

A character sequence length (or term length) index is applied to each term collected from the text, and the result as shown in FIG. 12B is obtained when the similarity is calculated from the commonality (extent of common usage) of the 3-grams and 4-grams. When the similarity of the character sequence length is 1 and four terms are selected in the order of high similarity as spelling variation candidates, the result as shown in FIG. 12C is obtained. The edit distance for these 4 terms is calculated using the cost, as was shown in FIG. 10. The term “ICCAR” that satisfied the condition of an edit distance threshold of 60 or less is retrieved as the true spelling variation.

### Second Exemplary Embodiment

In this example, the user enters a term (query) regarding the matter of interest when searching the documents. The term entered by the user is then collated with the index words appended in the documents. If the index word matches the user's term (query) then documents possessing that index word are provided as the results to the user. During this process, however, omissions will occur if there are spelling variations among the terms entered by the user and the index word attached to the document. The system of the present invention described below provides search results even for documents (text) when there are spelling variations of the term input by the user, by utilizing the means of the present invention in the text for terms input by the user and the index words.

The overall structure is the same as the structure of FIG. 1, however the text data 33 is stored as the primary data in the auxiliary storage unit S3 on the server. The index words 42 are stored as text data of the secondary data, and the N-gram data 52 for the index words are stored as the tertiary data.

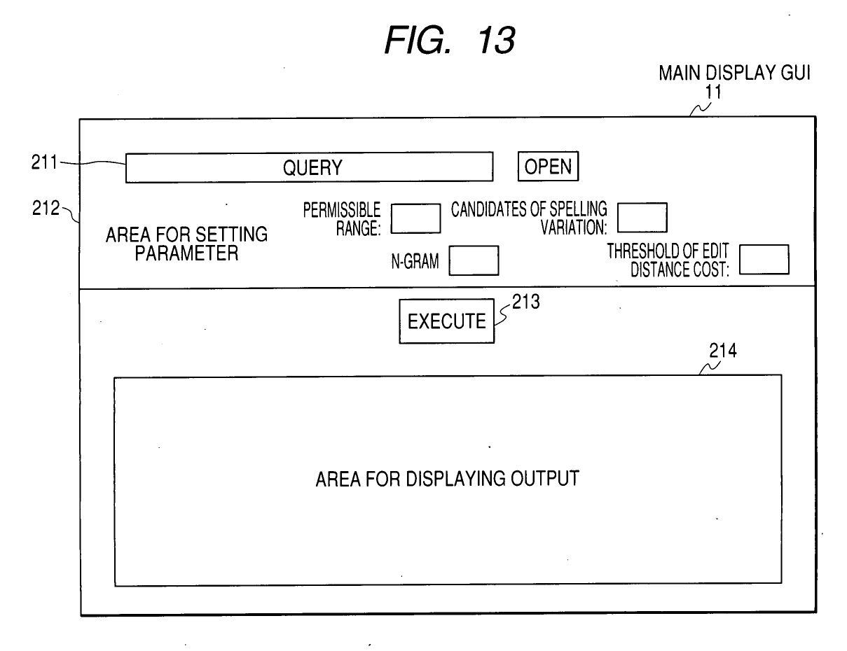

FIG. 13 shows an example of a user interface for making retrieval requests and setting parameters. The main display 11 for the GUI on the client computer device contains a section for entering queries 211, a section for entering parameters 212 such as the number of spelling variation candidates, an execute button 213, and an area for displaying output 214. The user may also specify a tolerance for the character sequence length that shows how much tolerance to impart to the character sequence length of the spelling variation candidate for the entry word, the number of spelling variation candidates, and how many consecutive characters each of elements to divide the text when generating N-grams on the section for entering parameters 212. Threshold values for the total cost for the edit distance may also be specified.

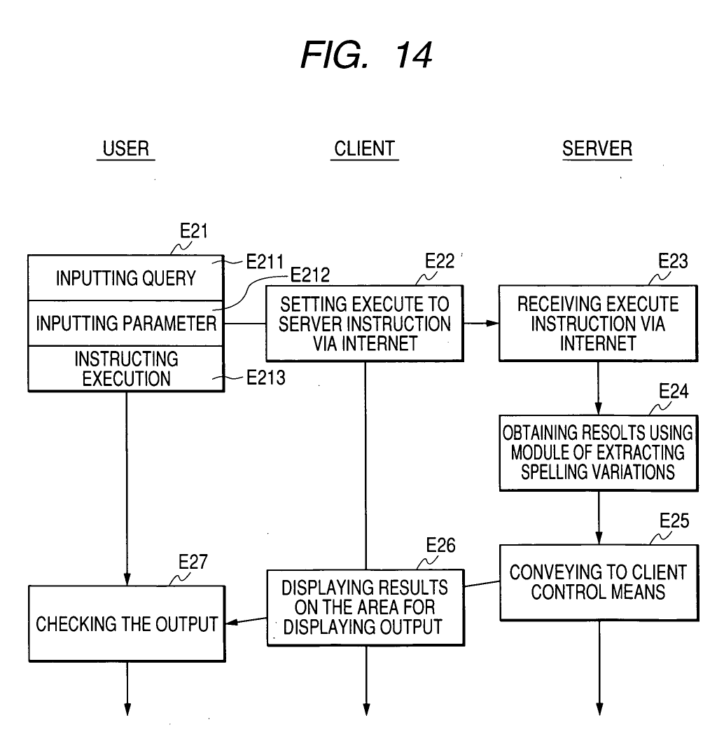

The process flow is described next using FIG. 14. The (vertical) line on the left shows the flow of the user operation. The (vertical) line in the center shows the process flow in the client computer device. The (vertical) line on the right shows the process flow in the server computer device. The user initially inputs the query in the inputting query E211 section (FIG. 13) on the main display. The user then sets the parameter values in the inputting query E212 section and seects the execute button 213 in E213 to instruct the collection of spelling variations. Collectively, these user functions are labeled E21.

The client control means (or module) P01 receives this instruction and conveys the dictionary, text, and parameter types over the communication network N (FIG. 1) such as a LAN or the Internet to the server control module P02 operating on the server computer device S (E22). If the client computer device and the server computer device are the same device then it (dictionary, text, parameters) is conveyed by communication means between processes.

The server control module P02 sends the query term and parameters to the module of extracting spelling variation means based on the task request that P02 received. The module of extracting spelling variation means P collects terms from the received text data 32 by using the module of collecting terms P11 and generates the secondary data 42. Next, the module of extracting spelling variation means P further processes the secondary data 42 by using the module of indexing P12 and generates the term-index data 52. The character sequence similarity of the query term is thereafter searched based on the extent of common (commonality) subsequences while checking the term-index data 52 by using the module of searching for similar character sequences P13.

The similar character sequences are at this time searched within the tolerance range for character sequence length set by the user by placing restrictions on character sequence length with the module of constraint based on sequence length P21. The module of ranking character sequence P22 ranks the character sequences by attaching a score for commonality of subsequences and establishes items with high similarity as candidate spelling variations. The candidate spelling variations obtained in this way are further selected as spelling variations based on the character string edit distance by using the module of extracting spelling variations P14 (collectively, E23, E24)

The terms obtained in this way are output as text in the form of index terms as the retrieval results. These (results) are again conveyed to the client control means P01 over the network or inter-process communication (E25). At the client control means P01, these returning results are displayed on the area for displaying output 214 (E26). The user may then check these results (E27).

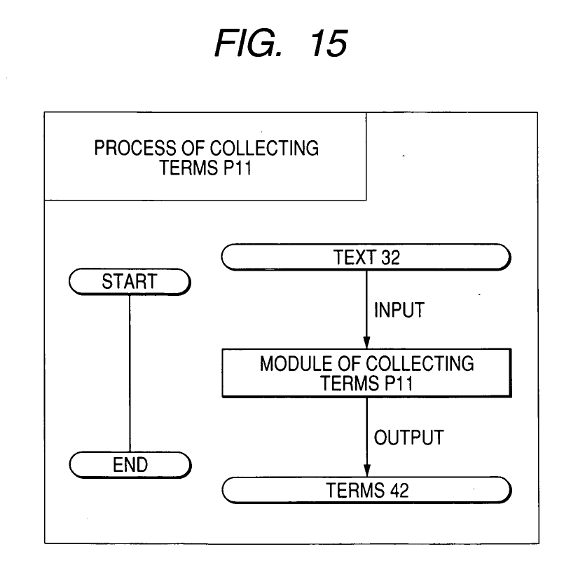

FIG. 15 is a diagram of the processing by the module of collecting terms P11. The module of collecting terms P11 collects terms from the text 32 and stores this secondary data as the collection of index words 42.

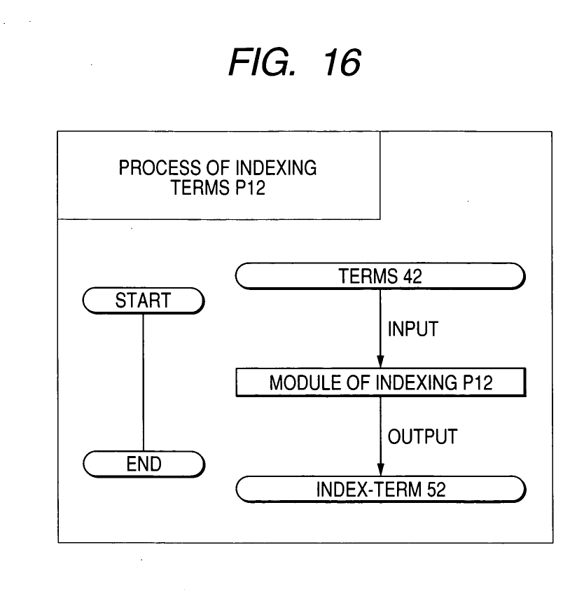

FIG. 16 is a diagram of the processing performed by the module of indexing P12 on the collection of index words 42 from the text. The tertiary data made by the module of indexing P12 from the collection of index words 42 is the term-index data 52.

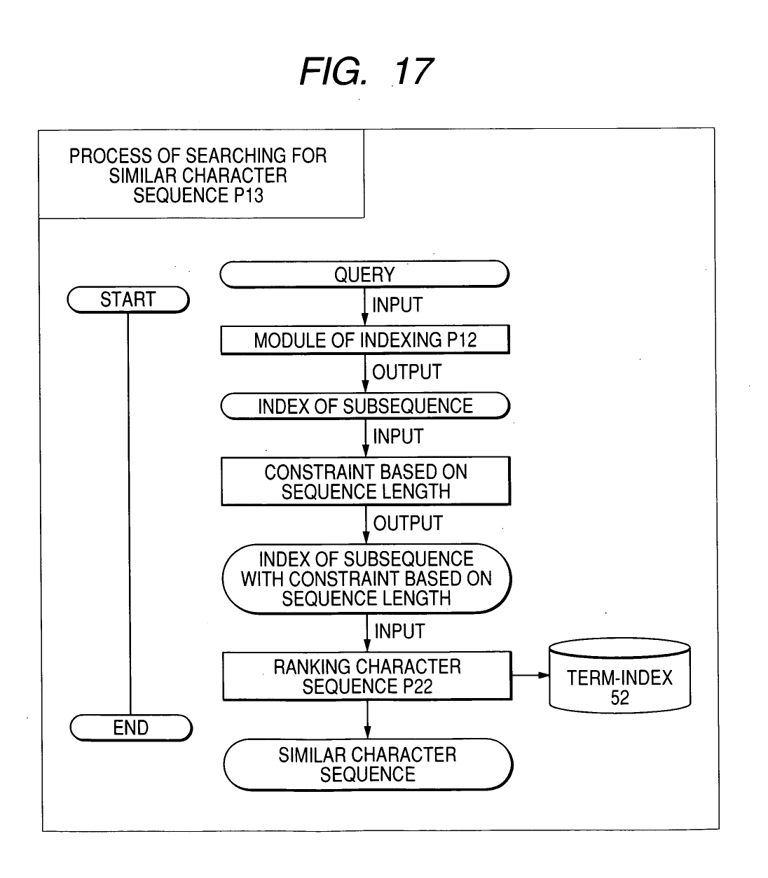

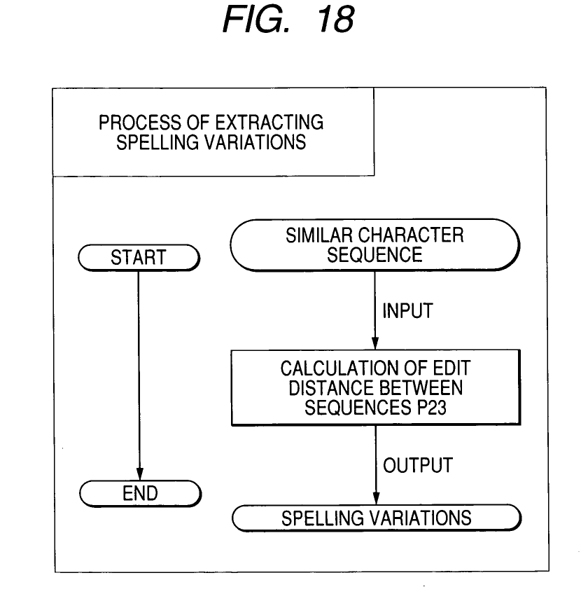

FIG. 17 is a diagram of the processing by the module of searching for similar character sequences P13, by utilizing common subsequences. The user inputs a query term, and the module of indexing P12 generates a subsequence index for that term. The character sequences increase and decrease per the spelling variations to as high as ±m so an index with a character sequence length of ±m is generated. The user specifies the value of m. When an index with a tolerance of ±1 is generated for the character sequence “iccar” with a character sequence length of 5, then the resulting sequence is: [ic, icc, cca, car, ar], with acceptable sequence lengths: “%4”, “6”.

The similarity of the index term 42 with the query term is calculated while referring to the tertiary data of the term-index data 52. To calculate the similarity, a weight is set for common index items, and the weight for all matching sections is summed. The total sum obtained by this calculation is the similarity per N-grams indexed by character sequence length. The similarity of “ICCAR” and “ICCA8” is 3 and the similarity of the character sequence length becomes 1. The similar character sequences are output as upper k^{th} units in the order of character sequences with high similarity. The user sets the value of k.

FIG. 18 is a diagram showing the processing by the module of extracting spelling variations P14 using the edit distance among the character sequences. Similar character sequences are input, and the edit distance between the character sequence and the query term is measured. To calculate this edit distance, an edit distance with a weight set for a low cost is utilized for the insertion, substitution and deletion of character sequences assumed to be spelling variations. In character sequences with a close edit distance, terms with an edit distance whose total cost is the same or lower than a threshold are acquired as character sequences for spelling variations of the query term.

Nothing in the above description is meant to limit the present invention to any specific materials, geometry, or orientation of elements. Many part/orientation substitutions are contemplated within the scope of the present invention and will be apparent to those skilled in the art. The embodiments described herein were presented by way of example only and should not be used to limit the scope of the invention.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the drawings and the descriptions herein are proffered only to facilitate comprehension of the invention and should not be construed to limit the scope thereof.

1. A spelling variation retrieval system for retrieving spelling variations for terms entered as query terms utilizing a supplied edit distance threshold, comprising:
a term collection module for collecting groups of terms from a text document;
a similar term query module for retrieving a group of similar terms from among the group of terms collected by the term collection module; and
a spelling variation query module to retrieve spelling variations of query terms from among the group of similar terms retrieved by the similar term query module, wherein
the similar term query module calculates a degree of similarity of two compared terms based on the extent of common usage in adjoining subsequences of a specified length, said subsequences being offset by one character place, and further wherein
the spelling variation query module retrieves spelling variations of query terms whose total cost for edit distance with the query terms is smaller than the supplied threshold value.

2. A spelling variation retrieval system according to claim 1, wherein the spelling variation query module calculates the edit distance for two terms by utilizing a cost assigned to character substitution, insertion, and deletion.

3. A spelling variation retrieval system according to claim 1, wherein the similar term query module retrieves groups of similar terms whose difference in number of character sequences versus the query term is within a supplied term length tolerance range.

4. A spelling variation retrieval system according to claim 1, further comprising:
an index generator module for generating an index of subsequences, said subsequences being offset by one character from the query term character sequence.

5. A spelling variation retrieval system according to claim 3, further comprising:
an input module for entering said term length tolerance range.

6. A spelling variation retrieval system according to claim 1, further comprising:
an input module for entering a value for said edit distance threshold and a value for a subsequence length threshold.

7. A spelling variation retrieval system according to claim 1, wherein multiple entry words of one dictionary are provided for the query term, and a spelling variation dictionary is constructed for the dictionary.

8. A spelling variation retrieval method for retrieving spelling variations of input query terms utilizing a computer, said method comprising the steps of:
collecting groups of terms from a text document;
calculating, utilizing a similar term query module, a degree of similarity of two compared terms based on the extent of common usage of adjoining subsequences of a specified length, said subsequences being offset by one character place; retrieving a group of terms that most resemble the input query terms based on said calculation;
calculating, utilizing a spelling variation query module, a total cost of the edit distance between each of said retrieved group of terms and the input query terms; and
retrieving a spelling variation of the query terms that satisfy a supplied threshold value for the total cost of the edit distance.

9. A spelling variation retrieval method according to claim 8, wherein the calculation utilizing the spelling variation query module calculates the edit distance for two terms by utilizing a cost assigned to character substitution, insertion, and deletion.

10. A spelling variation retrieval method according to claim 8, wherein said step of retrieving a group of terms that most resemble the input query terms based on said calculation is limited by a supplied tolerance range of acceptable character sequence lengths.

11. A spelling variation retrieval method according to claim 8, further comprising the step of:
utilizing an index generator module for generating an index of subsequences offset by one character from the query term character sequence.

12. A spelling variation retrieval method according to claim 10, further comprising the step of:
receiving said tolerance range from a user.

13. A spelling variation retrieval method according to claim 8, further comprising the step of:
receiving said supplied threshold value and receiving a threshold value for total sequence length from a user.

14. A spelling variation retrieval method according to claim 8, further comprising the step of:
sequentially executing processes on multiple entry words of one dictionary for the query term, and constructing a spelling variation dictionary for the dictionary.

15. A computer program adapted to enable a general purpose computer to execute a spelling variation retrieval program utilizing input query terms and a supplied edit distance threshold, including software modules comprising:
means for collecting groups of terms from a text document;
means for retrieving a group of similar terms from among the group of terms collected from a text document; and
means for retrieving spelling variations of query terms from among the group of similar terms, wherein
said means for retrieving a group of similar terms calculates a degree of similarity of two compared terms based on the extent of common usage in adjoining subsequences of a specified length, said subsequences being offset by one character place, and further wherein
said means for retrieving spelling variations of query terms retrieves spelling variations of query terms whose total cost for edit distance with the query terms is smaller than the supplied threshold value.

16. A computer program according to claim 15, wherein said means for retrieving spelling variations of query terms calculates the edit distance for two terms by utilizing a cost assigned to character substitution, insertion, and deletion.

17. A computer program according to claim 15, wherein said means for retrieving a group of similar terms retrieves groups of similar terms whose difference in number of character sequences versus the query term is within a supplied term length tolerance range.

18. A computer program according to claim 15, further comprising:
means for generating an index of subsequences, said subsequences being offset by one character from the query term character sequence.

19. A spelling variation retrieval system according to claim 17, further comprising:
means for entering said term length tolerance range.

20. A computer program according to claim 15, further comprising:
means for entering a value for said edit distance threshold and a value for a subsequence length threshold.
